(19) United States
(12) Patent Application Publication
(10) Pub. No.: US 2005/0152784 A1
(43) Pub. Date: Jul. 14, 2005

(54) Fan

(76) Inventor: Gines Rubio Sanchez, Madrid (ES)

Correspondence Address: GOTTLIEB RACKMAN & REISMAN PC, 270 MADISON AVENUE, 8TH FLOOR, NEW YORK, NY, 100160601, US

(21) Appl. No.: 10/505,827

(22) PCT Filed: Feb. 27, 2003
(86) PCT No.: PCT/ES03/00092

(30) Foreign Application Priority Data
Feb. 27, 2002 (ES) P200200480

(51) Int. Cl. F03D 5/06

(52) U.S. Cl. 416/79

(57) ABSTRACT

It comprises a kinematical system within a casing fixed to a ceiling which provides a swinging motion to an axis from where a fan is hanging by means of a crank and shaft system provided with a motor with a revolution's reduction mechanism, a speed variation electronic circuit which transmits swinging movement to an axis affixed transversely and supported through articulated rods bay means of a ball-and-socket joint, providing the swinging motion to the fan which is affixed to the axis strip or top by means of a pressure system acting in a sail ship wing like manner or by pressure through another catch strip parallel to or linked to the first one by means of screws. At the end of the fan another strip can be seen, providing weight and supporting on either ends respective essence containers.

### TECHNICAL FIELD OF THE INVENTION

The present invention relates to a fan, of the type comprising a kinematical system housed in a casing fixable to ceilings and the like, capable of providing a swinging or rocking motion to an axis from which hangs a wing, or fan strictly speaking. This invention provides remarkable advantages and innovations against the fans nowadays existing on the market with the same or similar function.

1. State of the Art

As a reference to the State of the Art it must be said that not much of the present art can contribute to the ancestral fanning system based on hanging a fan from the ceiling in a pendulous like manner, which was driven in a manual way, that, due to their greater efficiency and simplicity, has been replaced by modern turning blade fans.

Thus, old ceiling fans have not undergone a technical evolution and are being used almost exclusively in the Middle West countries, where they were originated. The drive is still manual, the necessary energy being communicated by means of a rope or the like.

Spanish patent No. ES 8902529 describes an electrical ceiling fan comprising an electrical drive motor, through a speed demultiplying kinematical system, an arm integral with a rigid or flexible laminar body, or wing, whose swinging motion moves the air in de desired area. The kinematical system of this fan is made of pulleys and gears, which have shown to pose some drawbacks from the kinematical and dynamic point of view, particularly those associated to the lack of regularity and smoothness in the movement of the laminar body or wing.

The present invention aims to overcome this drawbacks.

2. Explanation of the Invention

To this end, the object of the present invention is a fan, of the type described earlier, of a new concept and design, that in its essence is characterised in that the said kinematical system is made up of a crank and shaft mechanism, drivable by means of a motor with a revolution's reduction mechanism, an speed variation electronic circuit, and a silencer, the shaft transmitting the motion to a rocking lever which provides the swinging motion to a rod fixed transversely on its other end and which in turn is linked to fan axis by means of articulated arms.

According to another feature of the present invention, the shaft has adjustable articulation points, determining different angular paths for the wing.

In accordance with the invention, it is foreseen to obtain different motion angles of the fan, by means of varying the different lengths of the segments forming the crank and shaft mechanism.

According to another feature of the present invention, the rods are provided on its lower end of an articulated ball-and-socket joint system linked to the arm, which in turn can support another catch strip that secures the wing.

Preferably, the base of the wing is provided with a strip of a rigid material and of a certain weight, adapted to hold at its ends essence containers.

According to a preferred embodiment of the present invention, the length between the articulations of the shaft is comprised between 2 and 4 times the length between the articulations of the crank, being preferable a length ratio of approximately 3. In such a way, the kinematical performance of the system approaches a sinusoidal operation, which is optimum from the kinematical and dynamical point of view, for the present application.

According to the invention, the motor can be a linear motor and can comprise an inverter for the motor movement.

The motor can also comprise an encoder, for the electronic and numerical control of the speed thereof.

Thanks to the fan object of the present invention, a simple crank and shaft mechanism, operated by a motor provided with a silencer with a revolutions reduction mechanism and a speed variation electronic circuit, gives the fan a swinging motion, similarly to the traditional manner of driving, aimed to allow the traditional, beautiful ceiling fans to be used in such in such a way that, without reducing its ornamental nature, an efficient and convenient fan means is available.

### BRIEF DESCRIPTION OF THE DRAWINGS

There follows a description of the preferred, but not exclusive, forms of embodiment of the fan object of the present invention, for the better understanding of which there are attached some drawings, given merely by way of non limiting, illustrative example, in which:

FIG. 1 represents a perspective view of a preferred form of embodiment of the fan of the invention;

FIG. 2 corresponds to a front view of the fan, in which the mechanism is shown located within its casing;

FIG. 3 shows a transversal section of the latter; and

FIG. 4 outlines an elevational detailed view of the aforesaid mechanism.

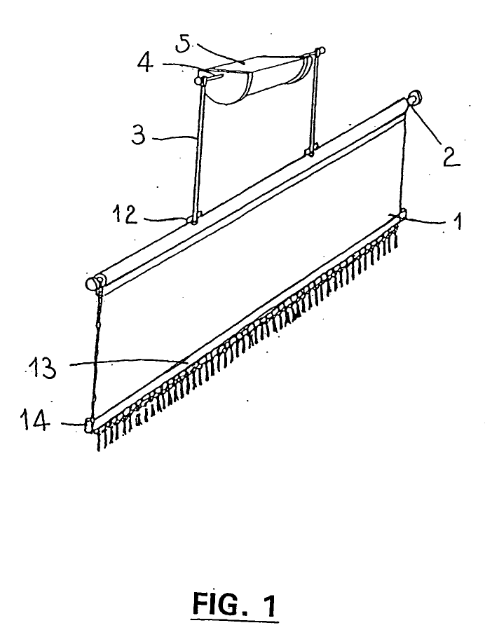

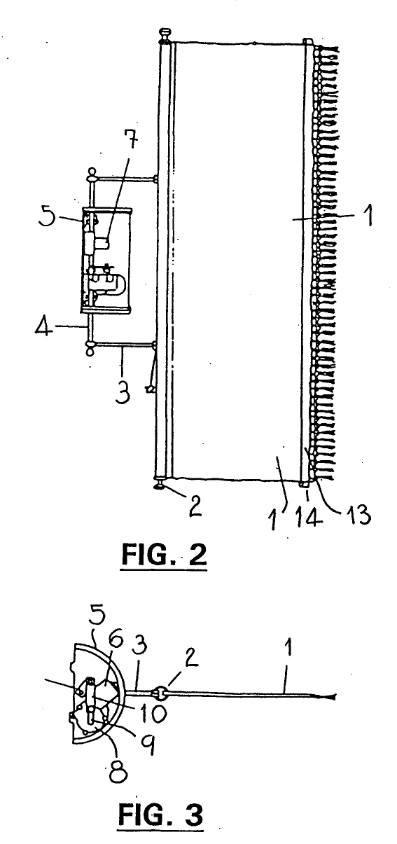

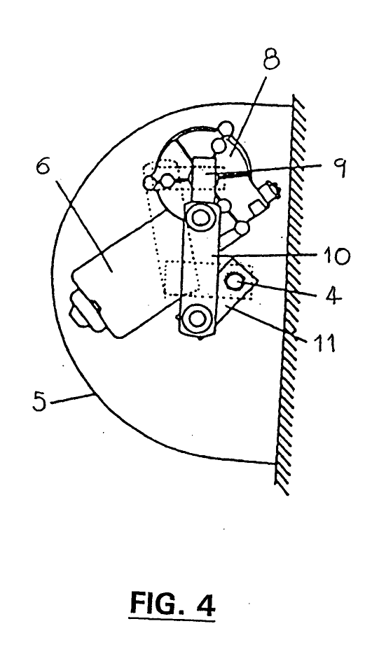

### DESCRIPTION OF THE PREFERRED EMBODIMENTS

Making reference to the drawings it is seen a form of put into practice the fan that, in its preferred embodiment, is made up of a wing or fan 1, strictly speaking, rigid or flexible, which is suspended from the rotation axis or top 2, linked trough arms 3 articulated by means of a ball-and-socket joint 12, permitting the swinging motion and impairing the togging of the rod 4 linked to the mechanism housed in the casing 5 fixed to the ceiling of the installation place, thus providing the fan with the traditional rocking motion.

This wing 1 is finished with a strip 13 of such a material that enough gap is produced for the wing 1 to remain strained, and finished at both ends by respective easy-to-replace essence containers 14.

The rotation axis or top 2 is formed with an strip opened in its centre from one end to another, allowing the pressure insertion of a rod or cutlass which, in its turn, holds the wing 1 and is inserted in the said opening in a sail ship wing like manner, the wing 1 being also susceptible of being attached to a second strip that, by means of screws at each end, can act as retaining loop against the top 2 or rotation axis.

The mechanism that provides the said motion to the wing 1 comprises a motor 6 which, being fed by the mains through a current adapter 7 by means of a revolutions reduction mechanism 8, a speed variation electronic circuit and equipped with a silencer, communicates the appropriated rotational motion to a crank 9 which, through a shaft 10, transmits the motion to a rocking lever 11 which provides to the rod 4 affixed thereto the swinging motion which is fed in turn to the wing 1.

After many tests, the inventors have found that the dynamic performance of the fan improves if the length between the articulations of the shaft 10 is comprised between 2 and 4 times the length between the articulations of the crank. Particularly, the dynamical performance is optimum when the length ratio between the shaft 10 and the crank 9 is 3, since the kinematics of the fan approaches to that of a sinusoidal motion, relating to speeds and accelerations.

The constant speed of motor 6 can be adjusted by means of an electronic circuit which, at the same time, allows to stop the movement in the vertical arrangement of the fan (angle of 0 degrees). The overall mechanism can be equipped with a remote control for the turning on, the turning off and the control of the speed.

In particular, motor 6 can be a linear motor and can be provided with an inverter for the motion of the motor 6, as well as with an encoder for the electronic and numerical control of the linear or rotational speed thereof.

Thus, with the present invention a simple and practical means for emulating the rocking motion of the traditional oriental fans is obtained, permitting at the same time to choose the most suitable path of the wing, according to the installation place thereof, or at user's choice

Obviously, the described elements can be replaced by their technical equivalents, the invention being susceptible of many variations and improvements, all of them falling within the scope of the attached claims.

1. Fan, comprising a kinematical system housed in a casing fixable to ceilings and the like, capable of providing a swinging or rocking motion to an axis from which hangs a wing (1), or fan strictly speaking, characterised in that the said kinematical system is made up of a crank (9) and shaft (10) mechanism, drivable by means of a motor (6) with a revolution's reduction mechanism (8), an speed variation electronic circuit, and a silencer, the shaft (10) transmitting the motion to a rocking lever (11) which provides the swinging motion to a rod (4) fixed transversely on its other end and which in turn is linked to fan (1) axis by means of articulated arms (3).

2. Fan, according to claim 1, characterised in that the rod shaft (10) has adjustable articulation points, determining different angular paths for the wing (1).

3. Fan, according to claim 1, characterised in that it is foreseen to obtain different motion angles of the fan (1), by means of varying the different lengths of the of the segments forming the crank (9) and shaft (10) mechanism.

4. Fan, according to claim 1, characterised in that the rods (3) are provided on its lower end of an articulated ball-and-socket joint system linked to the arm (2), which in turn can support another catch strip that secures the wing (1).

5. Fan, according to claim 1, characterised in that the base of the wing (1) is provided with a strip of a rigid material and of a certain weight, adapted to hold on either ends essence containers.

6. Fan, according to claim 2, characterised in that the length between the articulations of the shaft (1) is comprised between 2 and 4 times the length between the articulations of the crank (9).

7. Fan, according to claim 6, characterized in that the length between the articulations of the shaft (1) is approximately 3 times the length between the articulations of the crank (9).

8. Fan, according to claim 1, characterised in that the said motor (6) is a linear motor.

9. Fan, according to claim 1, characterised in that it comprises an inverter for the motor (6) movement.

10. Fan according to claim 1 characterised in that it comprises an encoder, for the electronic and numerical control of the driving speed of the motor (6).
